(19) United States
(12) Patent Application Publication
(10) Pub. No.: US 2019/0100943 A1
(43) Pub. Date: Apr. 4, 2019

(54) MOUNTABLE CONTAINER FOR ELECTRONIC DEVICE AND METHODS OF MAKING THE SAME

(71) Applicant: William Henricks, Glen Carbon, IL (US)

(72) Inventor: William Henricks, Glen Carbon, IL (US)

(21) Appl. No.: 15/722,403

(22) Filed: Oct. 2, 2017

(51) Int. Cl. E05B 73/00; G07C 9/00

(52) U.S. Cl. CPC E05B 73/00; A45C 2011/002; G07C 9/00571

(57) ABSTRACT

A mountable container for temporary storage of an electronic device includes a cover wall opposite a base wall and an opening mechanism configured to rotate the cover wall upwards from the container. A locking mechanism is configured to secure the cover wall over the receptacle, a bracket attached to the container, and an adjustable clamp attached to the bracket that may in turn be coupled to a support structure such as a desktop or tabletop.

### BACKGROUND OF THE INVENTION

This invention relates generally to mountable containers, and, more particularly, to a lockable container for temporarily storing an electronic device that can be mounted to a support structure.

With the integration of electronic technology in powerful mobile devices, individuals have an increasing desire to be connected with their technology wherever they happen to be. The increased number of applications accessible with handheld electronic devices has led to a proliferation of devices that are frequently used, and sometimes constantly used, for a variety of purposes. For example, people use their smart phones for not only making phone calls, but also for text messaging, sharing photos, browsing the internet, sending emails, and watching videos. Furthermore, electronic device ownership for people of all ages has greatly risen. For example, younger individuals carry electronic devices to keep in communication with friends and family, and sometimes use them for educational reasons in a school setting.

The constant access to electronic devices, and subsequently an almost infinite amount of communication and information accessible with them, can create adverse distractions that sometimes get in the way of completing important tasks. This may be especially true for younger individuals. For example, in the classroom setting, many students use their electronic devices as a distraction from learning.

### BRIEF DESCRIPTION OF THE INVENTION

In one aspect, a mountable container for a desktop is provided. The mountable container includes an opening and a receptacle. The container further includes a cover wall opposite a base wall coupled to the container configured to seal the receptacle, an opening mechanism configured to rotate the cover wall upwards from the container for unsealing the receptacle, and a locking mechanism configured to secure the cover wall over the receptacle.

In another aspect, a mountable container for a desktop is provided. The mountable container includes an opening and a receptacle. The container further includes a cover wall opposite a base wall coupled to the container configured to seal the receptacle, an opening mechanism configured to rotate the cover wall upwards from the container for unsealing the receptacle, a locking mechanism configured to secure the cover wall over the receptacle, and a bracket attached to the container.

In yet another aspect, a mountable container for a desktop is provided. The mountable container includes an opening and a receptacle. The container further includes a cover wall opposite a base wall coupled to the container configured to seal the receptacle, an opening mechanism configured to rotate the cover wall upwards from the container for unsealing the receptacle, a locking mechanism configured to secure the cover wall over the receptacle, a bracket attached to the container, and an adjustable clamp attached to the bracket.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is a perspective view of a container used in the tabletop mount system described herein.

FIG. 2 is a rear view of the container shown in FIG. 1 including a bracket and a clamp.

FIG. 3 is a side view on the container and clamp shown in FIGS. 1 and 2 attached to a desktop.

FIG. 4 is a side view of the container and clamp shown in FIGS. 1, 2, and 3 including rubber grips.

FIG. 5 is a perspective view of the container shown in FIG. 2 including a crank.

FIG. 6 is a schematic illustration of a system for locking the container shown in FIGS. 1-5.

FIG. 7 is a flow diagram of a method for making the mountable container shown in FIGS. 1-5.

### DETAILED DESCRIPTION OF THE INVENTION

The following detailed description illustrates the disclosure by way of example and not by way of limitation. The description clearly enables one skilled in the art to make and use the disclosure, describes several embodiments, adaptations, variations, alternatives, and use of the disclosure, including what is presently believed to be the best mode of carrying out the disclosure.

Although having constant access to information, and constant ability to communicate with other persons, is desirable in many aspects, it does create some problems in certain settings. For example, as described above, distractions in the classroom setting due to electronic device interruptions have become more prevalent due to the increased age-spread of electronic device usage. Individuals are adversely distracted when using their electronic devices in situations where their attention should be directed toward the subject matter in the classroom setting. Not only does this distract the individual actually using the electronic device, but it also distracts other individuals attempting to focus on the subject matter being taught.

Furthermore, in a live classroom setting with an instructor, the usage of electronic devices may distract the instructor as well. In a large classroom setting, it is difficult for the instructor to track, view, and correct each distraction.

A potential solution to the problems above may be to take away or ban the usage of electronic devices in the classroom setting. For many owners of the electronic devices, however, this solution may be too restrictive considering the wide acclamation of electronic device applications in everyday life. For example, in a situation where a parent desires their child to carry a mobile phone at all times in case of emergency, the banning of the device would be counterproductive.

Another potential solution may be to lock the electronic devices in a container to restrict access to the electronic device. However, not being able to view the electronic device creates problems in, for example, a situation as described above. As such, it would be desirable to provide a lockable container that is sized and dimensioned to receive an electronic device for temporary storage of an electronic device yet allowing hands-free conversation thereof, and that is also mountable a support structure or surface such as a desktop in a classroom or learning environment.

While described in the context of students in a classroom, the lockable container may serve similar purposes in other settings, such as, for example, conference room use in a business setting for adults who are prone to distracting use of electronic devices, or a movie theatre wherein restricted access to electronic devices may be desirable. As such, the lockable container is mountable to a tabletop, a chair, another piece of furniture or other support to accommodate a practically unlimited number of applications. The desktop and/or classroom environment is therefore described for the sake of illustration rather than limitation, and the benefits of the invention may accordingly accrue to other environments and mounting structures.

Exemplary embodiments of a mountable container and methods for assembly of the disclosure are described below that overcome the problems described above. The container may be sized and dimensioned to receive multiple sized electronic devices, including but not limited to, mobile phones, smart phones, tablets, and music media players. The mount included in the disclosure enables the securing of the container onto multiple sized desks, furniture, and tabletops to in different settings. Although the container includes a transparent portion to allow the user of the electronic device to view the electronic device (for example, in the case of an emergency), the container restricts the user from accessing the device using a cover for sealing and a locking mechanism.

In an exemplary embodiment, the locking mechanism may be configured to communicate with a remote control device, such that the remote control device is able to lock and unlock multiple containers within a certain distance.

In one example, the disclosure provides a mountable container for a desktop that is sized and dimensioned to receive an electronic device. The container may be made of any suitable material used for securing and protecting an electronic device, such as but not limited to, rubber, plastic, metal, and/or wood. Suitable electronic devices used in combination with the container include, but are not limited to, smart phones, mobile phones, tablets, smart watches, and/or media players.

The container defines an opening and a receptacle, such that the electronic device may be received in the receptacle of the container, and the electronic device may be viewed from the outside of the container through the opening while the container is closed and locked. As described above, the user of the electronic device is restricted from using the device while the device is locked inside the container, but is still able to view the device through the opening (for example, in the case of an emergency).

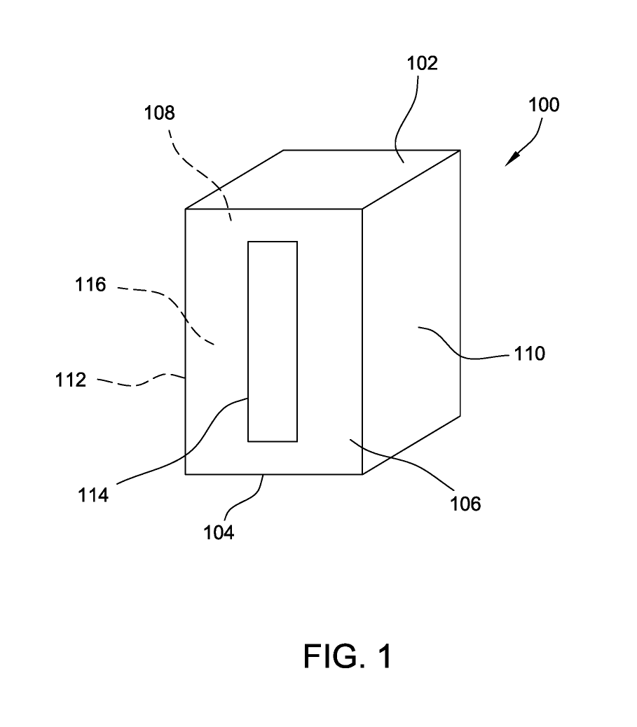

In an exemplary embodiment, the receptacle is defined by at least one outer wall, a cover wall coupled to the at least one outer wall, and a base wall coupled to the at least one outer wall and opposite the cover wall. For example (as described below in FIGS. 1-5), the container includes a first outer wall, a second outer wall coupled to and perpendicular to the first outer wall, a third outer wall coupled perpendicularly to the second outer wall and opposite the first outer wall, and a fourth outer wall coupled perpendicularly to the third outer wall and the first outer wall opposite the second outer wall. Although the container is rectangular shaped in the example embodiment, it should be known that the container may include other combinations of outer walls and container shapes suitable to receive an electronic device. For example, in some embodiments, the container may have one outer wall coupled to the cover wall and base wall. In such an embodiment, the outer wall may be a connected and continuous outer wall that gives the container a “rounded” shape. Various geometric shapes and configurations are possible.

As described above, the cover wall is located opposite the base wall and is coupled to the container. The cover wall is configured to seal the receptacle and thus the electronic device received inside the receptacle. More specifically, in the example embodiment, the cover wall is rotatable about one of its sides relative to the container. In a closed configuration, all sides of the cover wall are connected to the container restricting access to the receptacle. In an open configuration, the cover wall is rotated away from the container as described above, leaving a passageway for the container to receive an electronic device into the receptacle.

An opening mechanism is configured to rotate the cover wall upwards from the container for unsealing the receptacle. In the example embodiment, the opening mechanism is a spring-loaded mechanism coupled to the container and the cover wall. The opening mechanism may be activated in a number of ways, depending on the embodiment of the disclosure. For example, in the example embodiment, the container includes a battery that powers a switch, where the switch is connected to and communicated with the spring-loaded mechanism. The switch is further programmed to communicate with a remote device. To open the cover wall from the closed configuration, the remote device activates the switch, and the switch moves the spring loaded mechanism from a suppressed configuration into an extended configuration, thereby forcing the cover wall away (rotating away from) the container.

In some embodiments, the opening mechanism includes a lock-key mechanism for opening the container from the closed configuration. For example, the container may include a key hole that, when activated when a matching key is inserted, triggers the spring loaded mechanism to extend and force the cover wall away from the container.

In an exemplary embodiment, to close and secure the cover wall into the closed configuration, the cover wall is pushed downward towards the container, forcing the spring mechanism back into a suppressed configuration. In some embodiments, the switch mechanism may be configured to rotate the cover wall without the need for physical force (for example, a push). In this embodiment, the remote device may communicate to the switch mechanism, allowing for the switch mechanism to rotate the cover wall to the closed configuration.

As described above, the container further defines an opening that allows the electronic device to be viewed from outside the container. More specifically, an opening is located on at least one of the outer walls, the base wall, and/or the cover wall. In the example embodiment, the opening is rectangular. It should be known that the opening may be any suitable size and shape that allows for the viewing of the receptacle (and thus the electronic device inside the receptacle) from the outside of the container. The opening may be provided with a transparent element such as a clear plastic window, or may be a simple aperture or hole in the container allowing a portion of the electronic device to be viewed within the container. A user may therefore observe the device and its operation without having to remove the device from the container.

In an exemplary embodiment, the container may include a transparent wall attached to the container and covering the defined opening. The transparent wall restricts physical contact of the electronic device inside the receptacle, but is at least partly transparent to allow for viewing of the electronic device while the device remains inside. In this embodiment, the transparent wall may be made of any suitable transparent material, including but not limited to, glass and/or plastic.

In an exemplary embodiment, the container may further include a bracket attached to the container. The bracket is an overhanging member that is able to support a vertical load. The bracket includes multiple steps that allow for adjustment in the positioning of the vertical load. The bracket is attached to at least of the outer wall(s), the cover wall, and/or the base wall. In the example embodiment, the bracket is attached to the third outer wall opposite the defined opening. The steps define a plurality of grooves, and a clamp may be coupled in multiple different positions using selected ones of the grooves.

The container may likewise include an adjustable clamp attached to the bracket for securing to a portion of the desktop. The clamp may move along the steps of the bracket into different positions on the bracket. In the example embodiment, the clamp may be moved upward or downward relative to the bracket.

In an exemplary embodiment, the clamp includes a first side that attaches to the bracket. The clamp further includes a first edge and a second edge coupled to the first side. A mouth is defined between the first edge and the second edge. The mouth is sized to cover the portion of the desktop that the container is to be secured on. For example, the clamp is positioned over the edge of a desktop such that the mouth of the covers the desktop portion, the first edge of the clamp couples the top of the portion, and the second edge coupled the bottom of the portion.

In an exemplary embodiment, the clamp includes strips coupled to the first edge and the second edge and inside the mouth of the clamp. The strips allow for gripping of the first edge and the second edge onto the desktop portion in which the container is to be secured on. The strips also prevent damage to the desktop portion and the clamp from forced physical contact. In the example embodiment, the strips are made of a rubber material. In other embodiments, the strips are made of any other suitable material for securing onto the desktop portion.

In an exemplary embodiment, the clamp is adjustable such that the clamp may secure onto different sized desktop portions. For example, the first edge and the second edge may be movable about the first side of the clamp. The first edge and the second edge may be adjusted to either increase or decrease the distance between the first edge and the second edge, such that the mouth of the clamp is increased or decreased.

FIG. 1 is a perspective view of a container 100 used in, for example, a desktop or tabletop mount system. Container 100 defines an opening 114 and a receptacle 116, such that an electronic device (not shown) may be received in receptacle 116 of container 100, and may be viewed from the outside of container 100 through opening 114 (for example, by a user). As described above, the user of the electronic device is restricted from using the device while the device is inside container 100, but is still able to view the device through opening 114.

In the example embodiment, receptacle 116 is defined by at least one outer wall, a cover wall 102 opposite a base wall 104. Container 100 further includes a first outer wall 106, a second outer wall 112 coupled to and perpendicular to first outer wall 106, a third outer wall 108 coupled perpendicularly to second outer wall 112 and opposite first outer wall 106, and a fourth outer wall 110 coupled perpendicularly to third outer wall 108 and first outer wall 106 opposite second outer wall 112.

Although container 10 is rectangular shaped in FIG. 1, it should be known that container 100 may include other combinations of outer walls and container 100 shapes suitable to receive an electronic device. For example, in some embodiments, container 100 may have one outer wall 106 coupled to cover wall 102 and base wall 104. In this embodiment, outer wall 106 is a connected and continuous outer wall 106 that gives container 100 a “rounded” shape.

As described above, cover wall 102 is located opposite base wall 104 and is coupled to container 100. Cover wall 106 is configured to seal receptacle 114 and thus the electronic device received inside receptacle 114. More specifically, in the example embodiment, cover wall 102 is rotatable about one of its sides relative to container 100. In a closed configuration (as shown in FIG. 1), all sides of cover wall 102 are connected to container 100 restricting access to receptacle 114. In an open configuration (not shown), cover wall 102 is rotated away from container 100 as described above, leaving a passageway (not shown) for container 100 to receive an electronic device into receptacle 114.

As described above, container further defines opening 114 that allows the electronic device to be viewed from outside container 100. More specifically, opening 114 is located on at least one of the outer walls 106, 112, 108, and 110, base wall 104, and/or the cover wall 102. In the example embodiment, opening 114 is rectangular shaped. It should be known that opening 114 may be any suitable size and shape that allows for the viewing of receptacle 116 (and thus the electronic device inside receptacle 116) from the outside of container 100.

In the example embodiment, container 100 includes a transparent element attached to container 100 and covering opening 114. The transparent element restricts physical contact of the electronic device inside receptacle 116, but is transparent to allow for viewing of the electronic device. In this embodiment, the transparent wall may be made of any suitable transparent material, including but not limited to, glass and/or plastic. While the illustrated embodiment includes the opening 114 and the transparent element in one of the walls, the transparent element may in some cases be considered optional and need not be included. Likewise, in a case wherein one or more of the walls of the container are fabricated from a transparent material, an opening in the wall may be considered optional and need not be included.

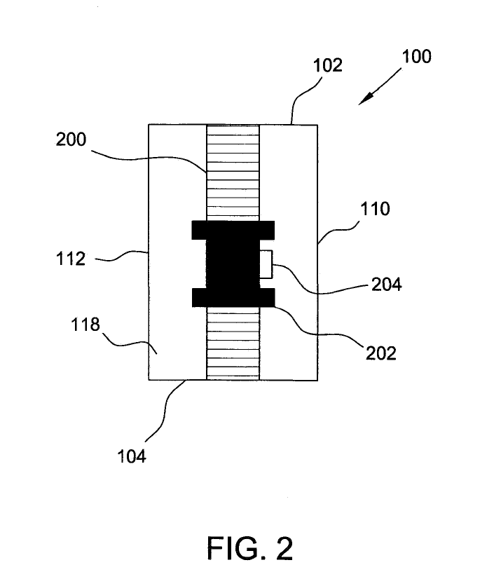

FIG. 2 is a rear view of container 100 shown in FIG. 1 including a bracket 200 and a clamp 202. In the example embodiment, container 100 further includes bracket 200 attached to container 100. As described above, bracket 200 is an overhanging member that is able to support a vertical load. Bracket 200 includes multiple steps that allow for adjustment in the positioning of the vertical load. Bracket 200 is attached to at least of the outer wall(s), cover wall 102, and/or base wall 104. In the example embodiment, as shown in FIG. 2, bracket 200 is attached to third outer wall 116 opposite opening 114 (shown in FIG. 1). The steps define a plurality of grooves, wherein clamp 202 is moveable about bracket 200. In the example embodiment, clamp 202 includes a knob 204. Knob 204 can be turned to move clamp 202 long bracket 200 for position adjustment. As described above, clamp 202 may move along the steps of bracket 200 into different positions on bracket 200. In the example embodiment, clamp 202 may be moved upward or downward relative to bracket 100.

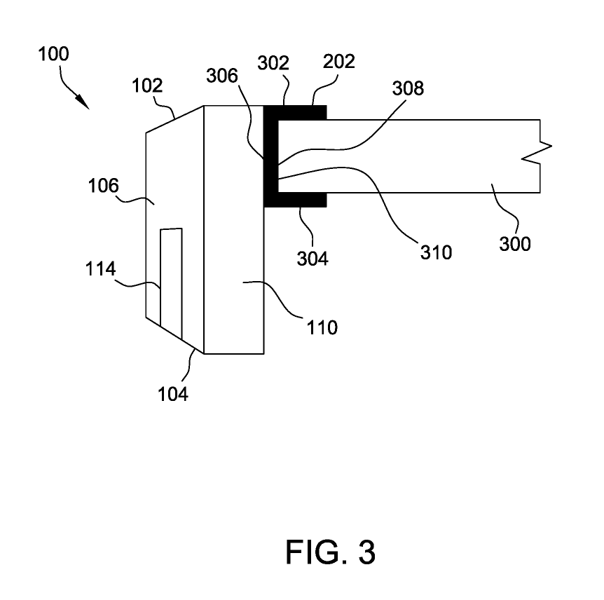

FIG. 3 is a side view of container 100 and clamp 202 shown in FIGS. 1 and 2. In the example embodiment, clamp 202 includes a first side 306 that attaches to bracket 200 (not shown in FIG. 3). Clamp 202 further includes a first edge 302 and a second edge 304 coupled to and extending away from first side 306. A mouth 308 is defined between first edge 302 and second edge 304.

Mouth 308 is sized to cover the portion of a desktop 300 that container 100 is to be secured on. For example, clamp 202 is positioned over the edge of desktop 300 such that mouth 308 covers desktop 300, first edge 302 of clamp 202 couples the top of desktop 300, and second edge 304 couples the bottom of desktop 300.

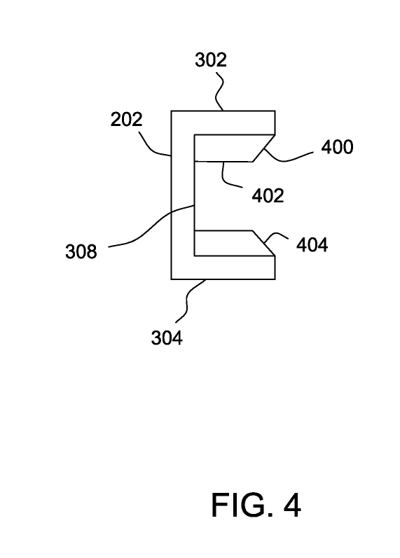

FIG. 4 is a side view of clamp 202 shown in FIGS. 2 and 3 including a first strip 402 and a second strip 404. First strip 402 and second strip 404 allow for gripping of first edge 302 and second edge 304 onto desktop 300 in which container 100 is to be secured on. First strip 302 and second strip 304 also prevent damage to desktop 300 and clamp 202 from forced physical contact. In the example embodiment, First strip 302 and second strip 304 are made of a rubber material. In other embodiments, first strip 402 and second strip 404 are made of any other suitable material for securing onto desktop 300.

In the example embodiment, clamp 202 is adjustable such that clamp 202 may secure onto different sized desktops or tabletops 300. For example, first edge 302 and second edge 304 may be movable about first side 306 of clamp 202. First edge 302 and second edge 304 may be adjusted to either increase or decrease the distance between first edge 302 and second edge 304, such that mouth 308 of clamp 302 is increased or decreased.

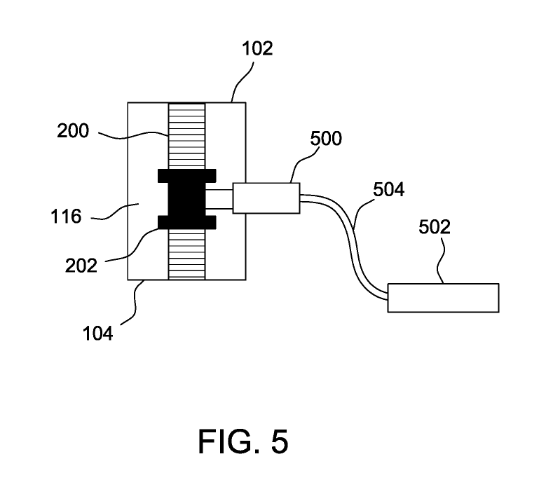

FIG. 5 is a rear view of container 100 shown in FIG. 2 including a crank 500. In some embodiments, clamp 202 may be movable about bracket 200 by using crank 500. Crank 500 includes handle 502 and arm 504. Crank 500 is detachable from clamp 202. Clamp 202 is movable about bracket 200 by attaching crank 500 to clamp 202, and rotating handle 502. It should be known that in other embodiments, any other suitable method for adjusting clamp 202 about bracket 200 may be used in place of crank 500.

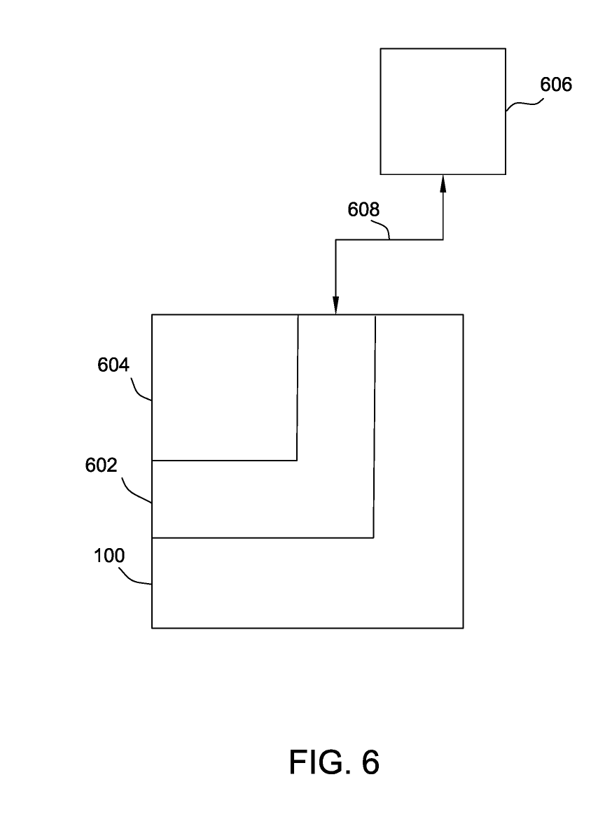

FIG. 6 schematically illustrates a system for opening and closing the container shown in FIGS. 1-5. The system includes container 100. Container 100 includes opening mechanism 602 and locking mechanism 604. In some embodiments, opening mechanism 602 and locking mechanism 604 are one in the same. Locking mechanism 604 is configured to secure cover wall 102 over receptacle 116.

As described above, opening mechanism 602 is configured to rotate cover wall 102 upwards from container 100 for unsealing receptacle 114. In the example embodiment, opening mechanism 602 is a spring loaded mechanism coupled to container 100 and cover wall 102. Opening mechanism 602 may be activated in a number of ways, depending on the embodiment of the disclosure. For example, in the example embodiment, container 100 and opening mechanism 602 includes a battery that powers a switch, where the switch is connected to and communicated with the spring loaded mechanism. The switch is further programmed to communicate using wireless connection 608 with a remote device 606 that may be a handheld, push-button key-fob like device for use by a teacher or an instructor. To open cover wall 102 from the closed configuration, remote device 606 when actuated activates the switch, and the switch moves the spring loaded mechanism from a suppressed configuration into an extended configuration, thereby forcing cover wall 102 away (rotating away from) container 100.

In the example embodiment, to close and secure cover wall 102 into the closed configuration, cover wall 102 is pushed downward towards container 100, forcing the spring mechanism back into a suppressed configuration. In some embodiments, the switch may be configured to rotate cover wall 102 without the need for physical force (for example, a push). In this embodiment, the remote device may communicate to the switch, allowing for the switch to rotate cover wall 102 to the closed configuration.

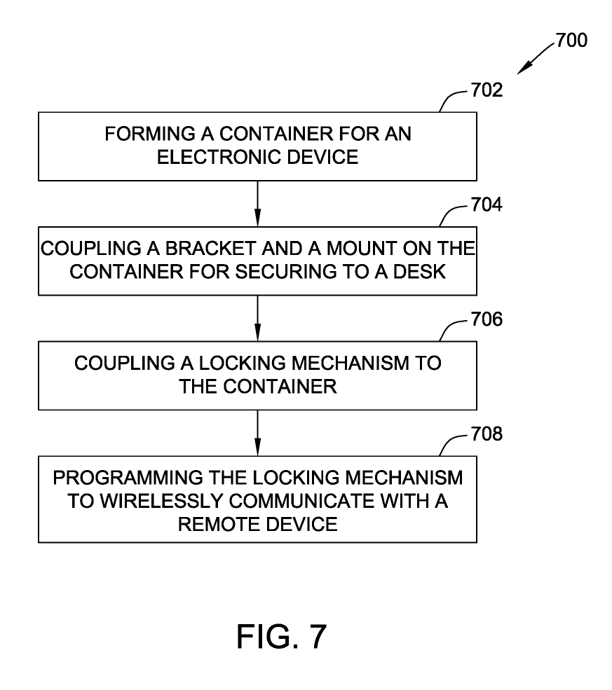

FIG. 7 is a flow diagram of a method 700 for making the mountable container shown in FIGS. 1-5. Method 700 includes forming 702 the container as described above. The container may be made of any suitable material used for securing and protecting an electronic device, such as but not limited to, rubber, plastic, metal, and/or wood. Suitable electronic devices used in combination with the container include, but are not limited to, smart phones, mobile phones, tablets, smart watches, and/or media players.

As described above, the container defines an opening and a receptacle, such that the electronic device may be received in the receptacle of the container, and may be viewed from the outside of the container through the opening. As described above, the user of the electronic device is restricted from using the device while the device is inside the container, but is still able to view the device through the opening (for example, in the case of an emergency).

The method further includes coupling 704 a bracket and a clamp to the container for securing to a desktop. As described above, the bracket is an overhanging member that is able to support a vertical load. The bracket includes multiple steps that allow for adjustment in the positioning of the vertical load. The bracket is attached to at least of the outer wall(s), the cover wall, and/or the base wall. In the example embodiment, the bracket is attached to the third outer wall opposite the defined opening. The steps define a plurality of grooves, wherein the clamp is moveable about the bracket.

The adjustable clamp is attached to the bracket for securing to a portion of the desktop. The clamp may move along the steps of the bracket into different positions on the bracket. In the example embodiment, the clamp may be moved upward or downward relative to the bracket.

Method 700 further includes coupling 706 at least one of an opening mechanism and or a locking mechanism to the container. The opening mechanism is configured to rotate the cover wall upwards from the container for unsealing the receptacle. In the example embodiment, the opening mechanism is a spring loaded mechanism coupled to the container and the cover wall.

The opening mechanism may be activated in a number of ways, depending on the embodiment of the disclosure. For example, in the example embodiment, the container includes a battery that powers a switch, where the switch is connected to and communicated with the spring loaded mechanism.

Method 700 further includes programming 708 at least one of the opening mechanism and/or locking mechanism to wirelessly communicate with a remote device. The switch is further programmed to communicate with a remote device. To open the cover wall from the closed configuration, the remote device activates the switch, and the switch moves the spring loaded mechanism from a suppressed configuration into an extended configuration, thereby forcing the cover wall away (rotating away from) the container. Programming of any processor-based elements included in the container and/or the remote device 606 is within the purview of those in the art and is not further explained herein.

Exemplary embodiments of a mountable container that includes a bracket and a clamp configured to secure to a desktop have been described above in detail. The container is not limited to the specific embodiments described herein, but rather, components of the container and/or steps of the method may be utilized independently and separately from other components and/or steps described herein. Further, the described components and/or method steps can also be defined in, or used in combination with, other apparatus and/or methods, and are not limited to practice with only the apparatus and method as described herein.

In contemplated embodiments, multiple containers are provided that may be attached to a tabletop adjacent each seat to be occupied by a student, or to each desk provided for use by a student. Once the container is mounted to the desktop or tabletop, a student may deposit his or her electronic device (e.g., a smartphone) into the container mounted adjacent his or her seat or mounted to his or her desk. While the containers described are configured to receive a single electronic device, in some cases the container may be configured to receive more than one electronic device such that students seated adjacent one another may each use a portion of the same container.

When class begins, the containers are locked are either individually or collectively via remote actuation, and during the class the students may observe their devices in the container and therefore may see, for example, if they have received a text message, but cannot access the device to respond to until the container is unlocked (typically at the end of the class or the end of the teaching portion of the class). As appropriate, however, the teacher may individually or collectively unlock the containers (individually or collectively) as needed so that, in the case of an emergency message to a student, the student may be allowed to respond. The device is therefore available if truly needed, but presents minimal distraction if not truly needed. The student may wait to respond or use the device until a subsequent time when the container is unlocked.

Numerous variations and adaptations are further possible. For example, in some cases, the containers may operate with respect to timers and thus automatically lock and unlock at designated times that can be synchronized with a school schedule, with capability to interrupt as needed and allow access to selected electronic devices in emergency situations (or other situations deemed appropriate by a teacher or instructor). Likewise, the containers may be manually locked and manually unlocked as desired without necessarily using a remote device. Finally, the same container may be operable in combinations of these modes (e.g., remotely unlockable, unlockable at an expiration of a timer or at a pre-selected time, and manually operable) such that the same teacher or instructor may use the device in different ways to meet the needs of different classes and different groups of students.

While the invention has been described in terms of various specific embodiments, those skilled in the art will recognize that the invention can be practiced with modification within the spirit and scope of the claims.

1-20. (canceled)

21. A temporary storage container assembly for restricting access to a portable electronic device in a group setting including at least one person prone to distracting use of the portable electronic device, the temporary storage container assembly comprising:
a container body including a plurality of side walls defining a receptacle, the receptacle being sized and dimensioned to contain the portable electronic device;
a cover including a plurality of side edges, one of the side edges being rotatably attached to one of the plurality of side walls of the container body, wherein the cover is rotatable away from the container body to an open position establishing a passageway to receive the portable electronic device, and wherein the cover is rotatable toward the container body to a closed position restricting physical access to the portable electronic device in the receptacle;
a locking mechanism maintaining the cover in the closed position, and
a switch coupled to the container body, the switch in communication with a remote control device in the group setting at a distance from the container body, the switch being responsive to the remote control device to unlock the locking mechanism, allowing the portable electronic device to be accessed in the group setting.

21. The temporary storage container assembly in accordance with claim 20 wherein at least one of the plurality of side walls of the container body and the cover wall includes a transparent portion allowing the portable electronic device to be viewed while the portable electronic device is in the receptacle and while the cover is in the closed position.

22. The temporary storage container assembly in accordance with claim 21, further comprising an opening mechanism configured to rotate the cover wall away from the outer wall when the switch is actuated by the remote control device.

23. The temporary storage container assembly in accordance with claim 21, wherein the switch is battery powered.

24. The temporary storage container assembly in accordance with claim 20, in combination with the remote device.

25. The temporary storage container assembly in accordance with claim 24, wherein the remote control device wirelessly communicates with the switch.

26. The temporary storage container assembly in accordance with claim 25, wherein the remote device is a push-button device operable by an instructor to communicate with the switch while the instructor is at a distance from the container body in the group setting.

27. The temporary storage container assembly in accordance with claim 20, wherein the portable electronic device is selected from the group consisting of a mobile phone, a smartphone, a tablet, a smart watch, and a music media player.

28. The temporary storage container assembly of claim 21, wherein the receptacle is sized and dimensioned to receive more than one portable electronic device.

29. The temporary storage container assembly of claim 20, further comprising a mounting bracket attachable to the container body and configured to secure the container body to a support structure in the group setting.

30. The temporary storage container assembly of claim 29, wherein the support structure is one of a desktop or a tabletop in the group setting.

31. A system for restricting access to portable electronic devices in a group setting including persons prone to distracting use of portable electronic devices in a group setting, the system comprising:
a plurality of temporary storage container assemblies arranged about the persons in the group setting, each of the plurality of temporary storage container assemblies comprising:
a container body including a plurality of side walls defining a receptacle, the receptacle being sized and dimensioned to contain a portable electronic device;
a cover including a plurality of side edges, one of the side edges being rotatably attached to one of the plurality of side walls of the container body, wherein the cover is rotatable away from the container body to an open position establishing a passageway to receive the portable electronic device, and wherein the cover is rotatable toward the container body to a closed position restricting physical access to the portable electronic device in the receptacle;
a locking mechanism maintaining the cover in the closed position, and
a switch coupled to the container body; and
a single remote control device in the group setting and in communication with each switch of each of the plurality of temporary storage container assemblies to selectively unlock the plurality of temporary storage container assemblies individually or collectively to permit physical access to the portable electronic device in each container assembly in the group setting.

32. A system in accordance with claim 31 wherein at least one of the plurality of side walls of the container body and the cover wall in each of the plurality of temporary storage container assemblies includes a transparent portion allowing a portable electronic device to be viewed while the portable electronic device is in the receptacle and while the cover is in the closed position.

33. A system in accordance with claim 32, wherein each of the plurality of temporary storage container assemblies further comprises an opening mechanism configured to rotate the cover wall away from the outer wall when the switch is actuated by the single remote control device.

34. A system in accordance with claim 33, wherein the switch of each of the plurality of temporary storage container assemblies is battery powered.

35. A system in accordance with claim 34, wherein the remote device is a push-button device operable by an instructor to wireless communicate with the switch of each of the plurality of temporary storage container assemblies while the instructor is at a distance from the container body in the group setting.

36. A system in accordance with claim 31, wherein the portable electronic device is selected from the group consisting of a mobile phone, a smartphone, a tablet, a smart watch, and a music media player.

37. A system in accordance with claim 31, further comprising a mounting bracket attachable to each container body and configured to secure the container body to a support structure in the group setting.

38. A system in accordance with claim 37, wherein the support structure is one of a desktop or a tabletop.

39. A method for restricting access to portable electronic devices in a group setting including persons prone to distracting use of portable electronic devices in a group setting, the portable electronic devices selected from the group consisting of a mobile phone, a smartphone, a tablet, a smart watch, and a music media player;
wherein the method is implemented with a system including:
a plurality of temporary storage container assemblies arranged about the persons in the group setting, each of the plurality of temporary storage container assemblies comprising:
a container body including a plurality of side walls defining a receptacle, the receptacle being sized and dimensioned to contain a portable electronic device;
a cover including a plurality of side edges, one of the side edges being rotatably attached to one of the plurality of side walls of the container body, wherein the cover is rotatable away from the container body to an open position establishing a passageway to receive the portable electronic device, and wherein the cover is rotatable toward the container body to a closed position restricting physical access to the portable electronic device in the receptacle;
a locking mechanism maintaining the cover in the closed position, and
a switch coupled to the container body; and
a single remote control device in the group setting and in communication with each switch of each of the plurality of temporary storage container assemblies to selectively unlock the plurality of temporary storage container assemblies individually or collectively to permit physical access to the portable electronic device in each container assembly in the group setting;
wherein the method comprises:
locking the plurality of temporary storage container assemblies after each person deposits a portable electronic device into the container assembly; and
selectively unlocking of each of the plurality of temporary storage container assemblies individually or collectively, via the remote control device and from a location within the group setting, to allow the respective persons access to the respective portable electronic devices in the group setting.

40. The method of claim 39, wherein selectively unlocking of each of the plurality of temporary storage container assemblies comprises activating, at a distance from the plurality of temporary storage container assemblies, a push-button device in wireless communication with the switch of each of the plurality of container assemblies.
